(19) United States
(12) Patent Application Publication
(10) Pub. No.: US 2006/0037339 A1
(43) Pub. Date: Feb. 23, 2006

(54) Roof-top air-conditioning system for a vehicle, particularly a bus

(76) Inventors: Karl-Heinz Hassel, Ostringen (DE); Siegbert Schon, Elsenz (DE); Vavrik Miroslac, Stary Kolin (CH)

Correspondence Address: MICHAEL BEST & FRIEDRICH, LLP, 100 E WISCONSIN AVENUE, MILWAUKEE, WI, 53202, US

(21) Appl. No.: 10/537,058

(22) PCT Filed: Sep. 14, 2004
(86) PCT No.: PCT/EP04/10270

§ 371 Date: Oct. 13, 2005

(30) Foreign Application Priority Data
Oct. 2, 2003 (DE) 10345997.9
Oct. 2, 2003 (DE) 20315237.9

(51) Int. Cl. B60H 1/32; F25D 17/04

(52) U.S. Cl. 62/244; 62/239; 62/407

(57) ABSTRACT

The invention relates to a roof-top air-conditioning system K, particularly for a bus, comprising a series of devices, which are subjected in succession to the action of internal coolant, and which consist of a high pressure-side heat exchanging device including a fan device, an expansion device, an evaporating device and an inner duct arrangement for guiding air, which is to be conditioned and which exchanges heat with the evaporating device. Said high pressure-side heat exchanging device has a modular design. According to the invention, connections for coupling modules of the same type can be provided, are prepared or are formed, and the modules are designed for a grid-like coupling of modules of the same output and/or of modules of stepped output.

This invention pertains to a rooftop air-conditioner for a vehicle, in particular a bus. Included for consideration are, in particular, land vehicles, which especially include commercial vehicles. In general, the needs of rail-operated and non rail-operated commercial vehicles are the issue. The main application of this invention is rooftop air conditioners on busses.

A rooftop air conditioner of this type that has the features of the preamble of claim 1 is known from the specification U.S. Pat. No. 4,679,616. In this known rooftop air conditioner, the entire high-pressure side heat exchanger and its associated fan are combined within a single housing as a first module. A second module represents the entire evaporator, which is called an evaporating device below for generalization purposes, and associated blowers. In the process, these two modules are not in turn further subdivided into smaller modules. The only provision is to remove either of these modules and to reinstall a new one or replace it, or to assemble the entire air-conditioner out of two such modules. Otherwise, the design of the air-conditioner is determined in a conventional manner according to the requirements of the respective vehicle. In particular, the intention was not to use identical modules for different output requirements on different vehicles. The use of multiple modules of a particular type, or even modules of identical or stepped output, was also not considered for the high-pressure side heat exchanging device on one hand or the evaporating device on the other. The streamlining effect possible with this patent's module design is thus still relatively minimal.

In general, the object of this invention is to further streamline an air-conditioner having the features of the preamble of claim 1, wherein special attention is first paid to the high-pressure side heat exchanging device. This device is a condensing device if operated subcritically and is a gas cooler if operated supercritically (see claim 29).

This general object is met through the features of claim 1.

The invention begins with the knowledge that the high-pressure side heat exchanging device is of foremost importance in comparison to the other components of the air-conditioner from the standpoint of manufacturing costs and that of space requirements on the roof of the vehicle. Realizing this, the invention abandons the dimensioning of the high-pressure side heat exchanging device according to the vehicle type. Rather, primary attention is paid to the simplicity of manufacture, storage and availability of modular components, which are called modules in this invention. Ideally, only a single type of module is used to construct the high-pressure side heat exchanging device. Such a module then has a minimum design, at least with regard to nominal output and pressure loss, and preferably with respect to the construction and dimensioning of all components and independent of the type of vehicle, such as a bus. If a higher nominal output is required, modularized assembly is carried out from such uniform, standardized modules according to the respective needs of the vehicle.

As touched upon later in connection with claim 8, the standardization of construction of the individual modules includes in particular a standardization of the housing of the individual modules. This pertains not just to its external dimensions, such as length, width, and height for rectangular modules, but ideally in it's entirety, which in turn allows for high volume production parts for the manufacture of the modules.

The concept of the invention is especially clear geometrically if at least two identical modules of this type are connected together. However, even if only one individual module of this type is used, the invention concept is fulfilled if this module comes from the module set named, which can also be used to construct high-pressure side heat exchanging devices with twice the nominal output by coupling two identical modules together, for example.

This is not to be confused with the manner of design of the prior art mentioned in specification U.S. Pat. No. 4,679,616, from which this invention derives, namely of always using only a single module for the high-pressure side heat exchanging device and to re-dimension and configure this module individually for each vehicle design and thus to not provide it modularly for different vehicle types.

The manner of design according to the invention is also not to be confused with the known design modes of connecting together different numbers of high-volume production parts inside a vehicle-specific housing depending on the nominal output even if such production parts are in turn called modules in the respective publications.

Thus, in specification U.S. Pat. No. 5,121,613A, such production parts are disclosed which are designed as heat exchanger elements with finned coolant conveying tubes, any number of which can be placed inside the housing of a stationary cooling system. Furthermore, in a rooftop air-conditioner for a vehicle according to specification DE 195 05 403 C2, an arbitrary number of different production parts of both a high-pressure side heat exchanging device as well as an evaporating device are coupled together this way both in the longitudinal as well as the transverse direction of the vehicle in but a single vehicle specific housing; these include evaporator elements on one hand and condenser elements on the other. A similar concept is put forth in German specification DE 77 14 617 U1 in its vehicle rooftop air-conditioner with condenser packages and evaporator packages, each designed as a high volume part, that extend in the longitudinal direction of the vehicle and each of which has a standard design length, and with identical production elements being coupled in the transverse direction.

The purest form of a rooftop air-conditioner according to the invention is realized if modules with the same nominal output are available only in modular kits for high-pressure side heat exchanging devices of different nominal output, at least one module of which, in other cases two or more modules of the same type being coupled together in the form of a grid based on the desired nominal output. However, the invention does not exclude also incorporating different base modules that have different nominal outputs in the modular system of the available modules for high-pressure side heat exchanging devices, wherein these can represent multiples of the smallest base module's nominal output, for example whole number multiples of the output, or are even stepped at other output ratios as a result of practical requirements. In all cases, however, the purpose is to provide a small number of modules of different nominal output in kits containing these modules. As will become more clearly specified later, as few as three module types with different nominal outputs can be enough for practically all requirements of busses' that contain modules for the high-pressure side heat exchanging device. Moreover, these three types can even be identical with regard to exterior geometrical dimensions (for the latter case, see claim 16).

In a vehicle of general type, the roof area available for the installation of a rooftop air-conditioner is usually considerably longer in the longitudinal direction of the vehicle than it is in the width of the vehicle. This generally applies for busses. From this standpoint, it is worth recommending that where modular coupling is used, the coupling of multiple modules should be done in the longitudinal direction of the vehicle. Thus, the coupling elements that are to be provided on the module itself or separately must be arranged in accordance with such a coupling method. The coupling elements can be of many types. In addition to couplings of all kinds, soldered, welded, screwed or riveted connections can be made as well, for example.

However, the concept of providing coupling of the modules in the longitudinal direction of the vehicle does not just include this general point of view, but can also be further specialized in consideration of the geometry of the module on the roof. Thus, the module can in principle have any base surface shape with which to cover the vehicle roof surface. A special case would be a square base surface. However, the module will usually have an elongated base surface which then usually has the basic shape of a squared or rounded rectangle. The concept of coupling modules in the longitudinal direction of the vehicle would then also include the conceptual possibility of placing the high-pressure side heat exchanging device modules laterally with respect to the longitudinal axis of the vehicle roof and in the process coupling them side by side in the longitudinal direction of the vehicle. By far, however, the preferred method is an arrangement in which the base surface of the module is elongated and in which the longitudinal axis of the module either aligns with, runs parallel to, or is at least mostly oriented with the longitudinal axis of the vehicle or its upper roof surface.

Moreover, the concept of the invention is invariably geared toward the decision to use round tubes or flat tubes for the air-conditioner. It is rather preferred (claim 5) to dimension the housing of the high-pressure side heat exchanging device, said housing present in any case for the module, such that either round tubes or flat tubes can be installed with which to convey the internal coolant. This provides the ability to offer the module in kit form or stocked for delivery by the manufacturer or dealer only as a semi-finished part and to leave it up to the customer as to whether he would like to use round or flat tubes in the vehicle depending on his requirements. This does not preclude the manufacturer from installing round or flat tubes at the outset for high volume production series.

The basic structure of the rooftop air conditioner according to the invention assumes that the air to be conditioned is to be cooled (see the elements of claim 1). However, pursuant to the general meaning of the term air-conditioning, the rooftop air conditioner according to the invention can also be further formulated for selective use as a heater for the air to be conditioned; this is accomplished by the air conditioner containing an additional heating device to heat the air to be conditioned. A preferred physical arrangement is indicated in claim 7 in this regard. Here, the assumption is to provide a heat conductor in the usual manner using the generally known technology as the main configuration, usually taken from the cooling circuit of an internal combustion engine of the vehicle. If this is not available, or if [it can't be used] for some other reason, an electrical heating device can also be provided, for example, or one can be installed as a general supplement.

If only one type of high-pressure side heat exchanger device module is used, the modules [must] have the same base surfaces from the outset due to their being high volume production parts. If, however, more than one module of different nominal output are provided in kit form in the manner already explained, the intent is to arrange at least a few, and preferably all, of the modules in a coupling grid on the roof of the vehicle, each of which has at least the same length in the longitudinal direction. In the process, particular reference is made to the preferred case already explained in which the modules are elongated and their longitudinal axes are oriented along the vehicle axis or its roof or coincide with it in particular or are parallel to it. The possibility is not precluded, in fact is preferred, that at least a few, preferably all, of the modules have the same transverse length within the grid.

Every rooftop air-conditioner according to the invention also has an internal channel arrangement to guide the air to be conditioned. As regards the invention, what is preferred is a manner of construction in which the internal channel arrangement—which may in turn be manufactured in modular fashion with its own housing—is produced separate from the high-pressure side heat exchanging device module and is attached to it laterally. However, the invention does not preclude an even larger [broader] integration solution of the high-pressure side heat exchanging device module in which at least one section of the internal channel arrangement is incorporated into the high-pressure side heat exchanging device module, preferably wherein an evaporating device can be incorporated into the high-pressure side heat exchanging device module as well. This latter option is again not to be confused with the concept of manufacturing a rooftop air-conditioner as a unit specific to a vehicle type, which can also be called a module and which can be installed on vehicles of the same type in series after they are pre-made. In this case, again, the only concept put forth by the invention is to have modular units that are based on the same nominal output, and in the process on the same pressure loss, said units capable of being coupled in a grid as modules if more than one minimum output is required and of being arranged already coupled on the roof of the vehicle if from the outset the nominal output is to be provided in smaller units.

Regardless of whether the evaporating device is incorporated into the high-pressure side heat exchanging device module or not, it is useful to arrange the evaporating device lateral to the internal channel arrangement; this always provides good area distribution of the rooftop air-conditioner.

In a preferred embodiment, the evaporating device and/or the internal channel arrangement is/are designed modularly with its/their own housing. It is conceivable in the process to provide only one module for each internal channel device or at least one section of the same and/or for the evaporating device for all high-pressure side heat exchanging device modules of differing nominal output. As regards the invention, however, to ensure high modular flexibility when constructing the entire rooftop air-conditioner, a [conceptual] continuation is added at this point in which the evaporating device is itself available in only a few useful output levels, thus providing sufficient selectivity from all the different modular kits depending on the design of the entire rooftop air-conditioner. This general concept (see claim 12) can then be further continued (see claim 16) by keeping the design of the high-pressure side heat exchanging device module and/or the evaporating device modules otherwise the same and by making the nominal output levels solely (preferred) or essentially determined by the number of identical fan units in the high-pressure side heat exchanging device module or blower units in the evaporating device that are selected appropriately. In the process, the respective modules are prepared such that a relatively small (variable) number of identical blower or fan unit designs are used in the module, their only difference being in their output, or are exchangeable with units of different nominal output. This concept makes it possible to change the level of nominal heat exchanger output or evaporation output internally while maintaining the same external design of the respective modules.

What was already touched upon was that the high-pressure side heat exchanging device, i.e. its module, extends in the longitudinal direction of the vehicle. In a continuation of this concept (see claim 17), the evaporation device and at least one section of the internal channel arrangement also extends/extend in the longitudinal direction of the vehicle or the high-pressure side heat exchanging device module, which is especially favorable if the evaporation device and at least a section of the internal channel arrangement are also modularly constructed.

Regardless of whether the internal channel arrangement and the evaporation device itself are arranged modularly or not, whereupon they constitute their own section, which is particularly useful in the transverse direction, adjustments can be made in the transverse direction according to the curved shape of the roof of the vehicle by means of special geometries of the rooftop air-conditioner in the transverse direction of the vehicle pursuant to claims 13 through 15. If, in particular, the different modules or even just corresponding arrangement sections have seams that run along or are oriented in the longitudinal direction of the vehicle, this makes it possible to arranged at least one pair of sections, modules or series of sections and modules that are adjacent to one another in the transverse direction at an angle with respect to the adjacent section or the adjacent module, wherein as seen in the entire transverse direction multiple angling can take place that mimics the curve or otherwise angling of the installation surface on the roof of the vehicle or that at least adjusts to it. In the process, established hinged couplings can be made between the adjacent sections, modules or pairs of sections or modules, which is especially meaningful for successive modules in the transverse direction. In sections or series of sections or modules that follow in the transverse direction, fixed-angle connections can also be made. An especially preferred useful variation of the angular connection consists in providing it as an intended bending point between adjacent modules, sections or pairs of modules and sections. This is not only constructively simple, but can also make installation work on the roof easy if use is made of the weight of the adjacent areas of the rooftop air-conditioner to allow them to bend relative to one another during roof installation so as to adjust the desired final angular position on the roof of the vehicle. In this case utilization of the actual weight of areas of the rooftop air-conditioner allows one to even forego the use of tools to fix the respective angular positions since this fixation is permanently guaranteed by the weight of the modules or sections. This does not preclude one from still providing angular attachments for safety considerations alone.

Whereas the latter measures illustrated pertain to the tailoring to a spatial constraints of the installation surface on the vehicle's roof that is not flat in the transverse direction of the vehicle, claim 15 pertains to another type of adjustment according to different installation surfaces in the transverse direction of the vehicle to the extent that they are namely of different widths. For reasons of even weight distribution, it is recommended in such cases that the rooftop air-conditioner be distributed over the entire width of the installation surface on the vehicle, for purposes of which at least one bridging device is provided between the pairs of sections and modules or between the section and module that are adjacent to one another in the transverse direction in order to compensate for the construction in this transverse direction, which is at least partially modular or else fixed in the width direction (see claim 15).

Preferably (pursuant to claim 18) the rooftop air-conditioner is designed to be symmetric in the transverse direction with respect to its center, wherein the center is aligned with the arrangement of the high-pressure side heat exchanging device. On both sides, then, the internal channel arrangement is the first adjoining member on the outside, on the outside of which in turn on both sides is the evaporating device, wherein the latter is coupled to the expansion device.

For a bus, but even for a few other vehicles, a rooftop air-conditioner is arranged for the purposes of installing a switching valve that can be switched between two operating modes, one of which is the conditioning of the interior air in the vehicle, the other being the conditioning of outside air introduced to the vehicle, or that can operate a mixed state between the two. In particular, for the modular construction of at least a section of the internal channel arrangement of the rooftop air-conditioner, it is useful to provide a space inside the channel arrangement to install such a switching valve or in which it can be installed. This switching valve can consist in an entirely conventional manner of an adjustable plate.

In rooftop air-conditioners, the high-pressure side heat exchanging device is conventionally installed in the direction of flow of the internal coolant downstream of a compressing device, which is not located within the air-conditioner as with the high-pressure side heat exchanging device [sic], but in the engine compartment of the vehicle, or is at least driven mechanically or hydraulically by the vehicle. In a further streamlining, it is within the scope of the invention to preferably incorporate such a compressing device into the rooftop air-conditioner as well and indeed logically next to its fan device in at least one high-pressure side heat exchanging device module. Preferably, the supplemental compressing device itself represents a module with its own housing.

Another supplement to a high-pressure side heat exchanging device module in addition to the fan device for the rooftop air-conditioner according to the invention is illustrated in claims 22 through 28, which pertain to the incorporation of a fuel cell device as a continuation of concept. If the compressing device is incorporated into the rooftop air-conditioner, the fuel cell device acts at least as a source of operating power for this compressing device and also, perhaps otherwise as a supplement for power generation when using the rooftop air-conditioner for heating purposes as well, for example. The fans and blowers also need to be provided with electrical power. This does not preclude the fuel cell device from also being used for miscellaneous purposes, such as an auxiliary power system for the vehicle itself.

The operating mode of the rooftop air-conditioner can be designed according to the decades-old conventional subcritical technology or according to modern supercritical technology, wherein supercritical operation uses carbon dioxide as a working fluid for the internal coolant, for example. In the latter case, the high-pressure side heat exchanging device or its module contains preferably a gas cooler as well for the internal coolant (see claim 29).

The invention is explained in more detail with the help of schematic drawings of numerous exemplary embodiments as follows. Shown are:

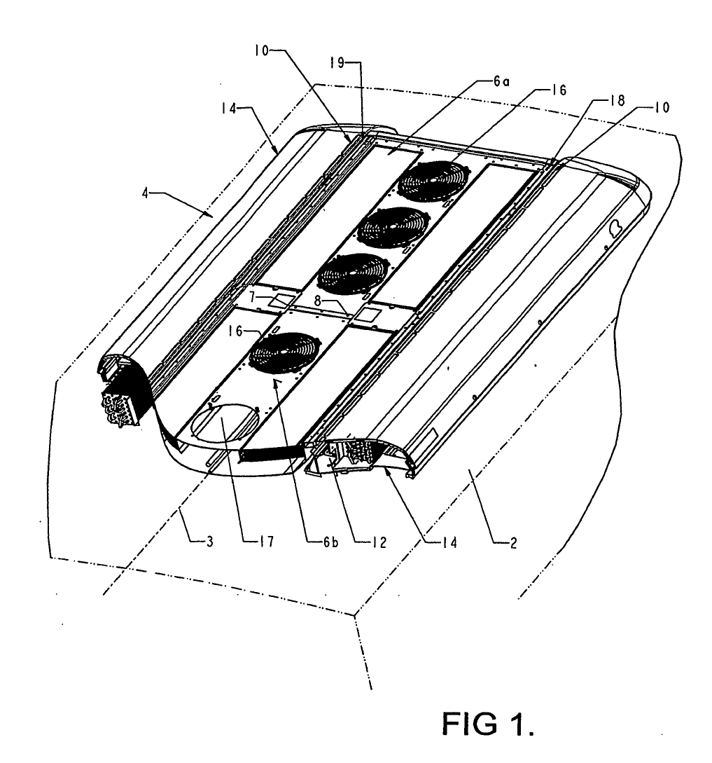

FIG. 1 an oblique sectional top view of a first embodiment of a rooftop air-conditioner;

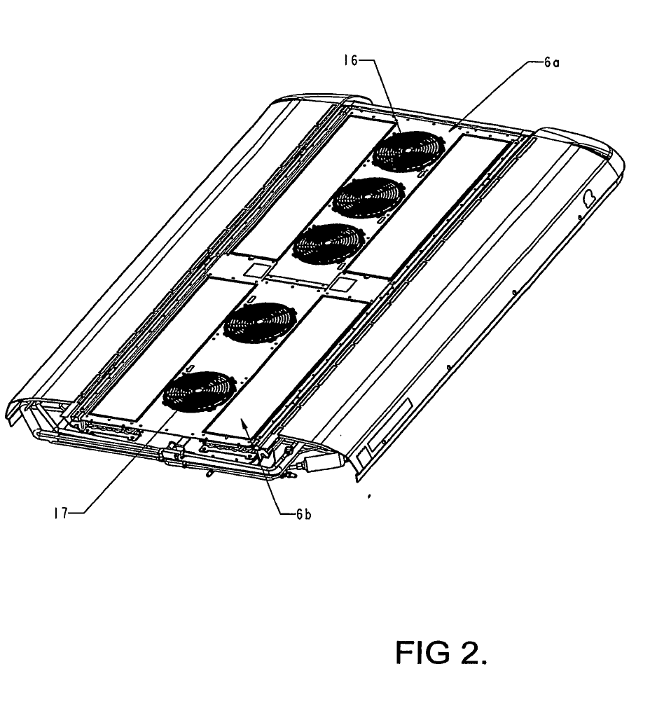

FIG. 2 in the same representation as FIG. 1 a second embodiment with the same construction as the first embodiment, but not sectional and with a different nominal output;

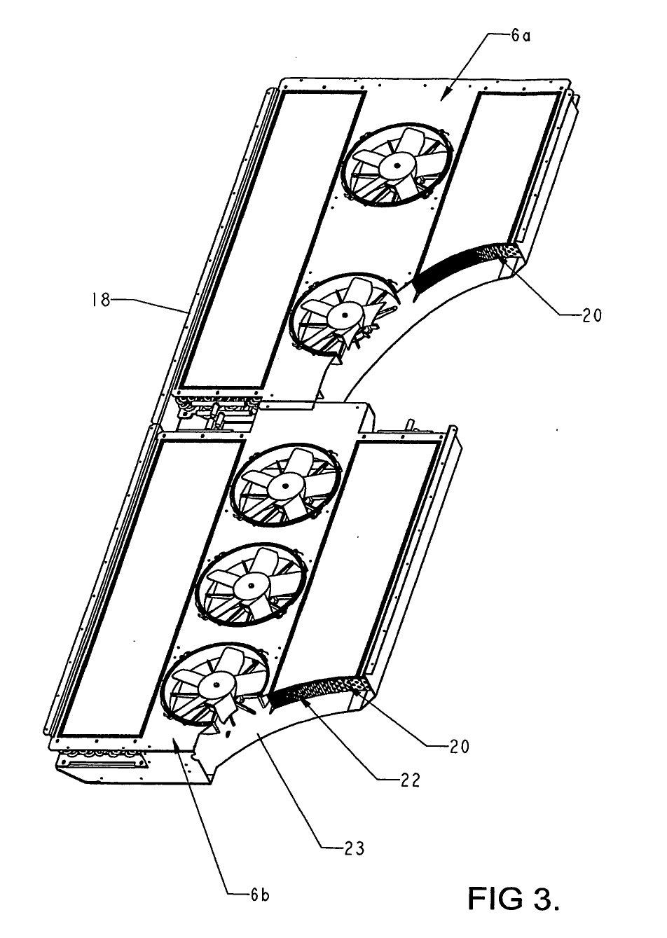

FIG. 3 a sectional separate drawing of the high-pressure side heat exchanging device of FIG. 2;

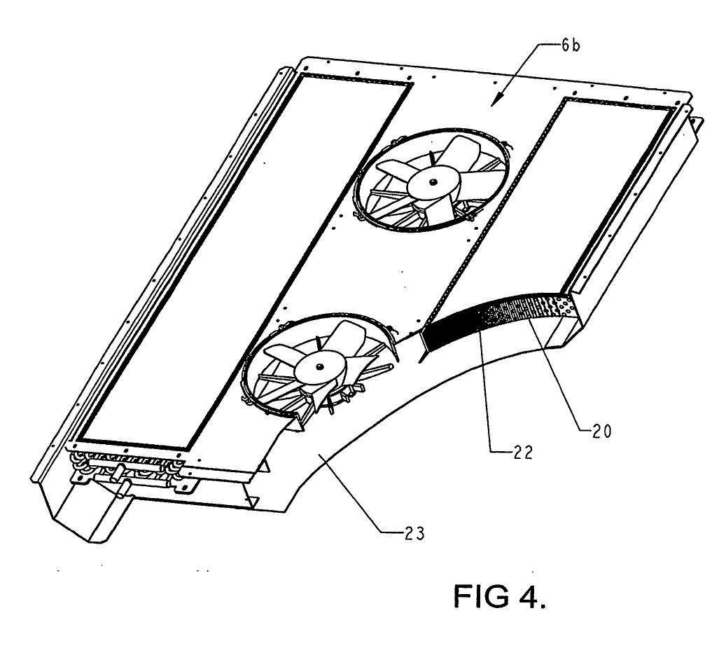

FIG. 4 an enlarged separate drawing of a high-pressure side heat exchanging device module according to FIG. 3;

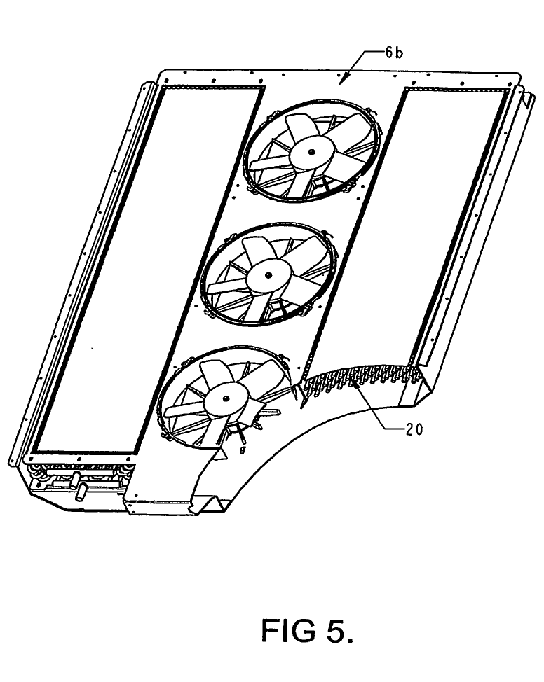

FIG. 5 a variation of FIG. 4 with a high nominal output but identical basic construction;

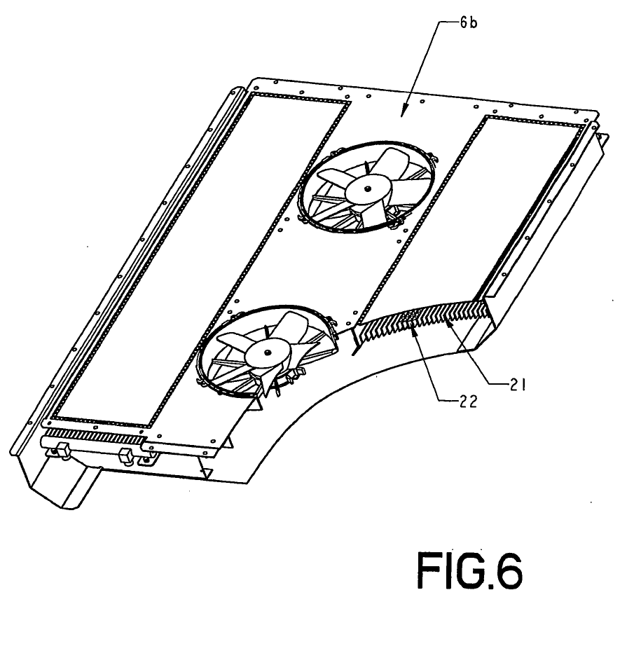

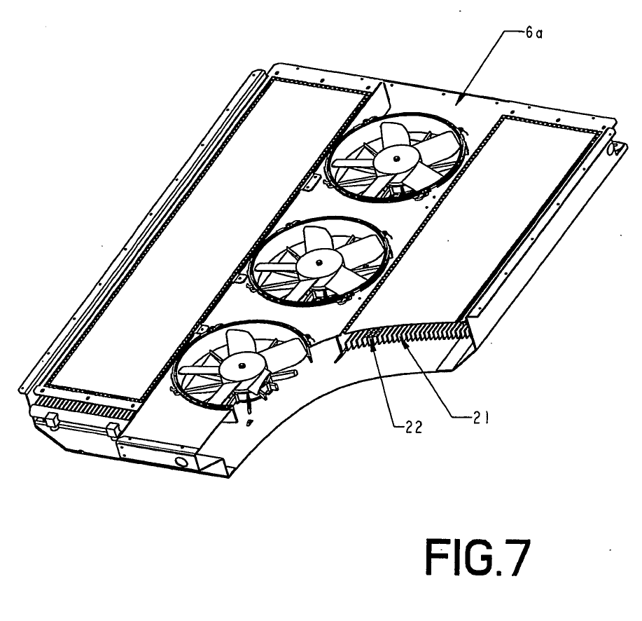

FIGS. 6 and 7 Representations according to FIG. 4 and FIG. 5, but with different tube geometries for the internal coolant guide tubes;

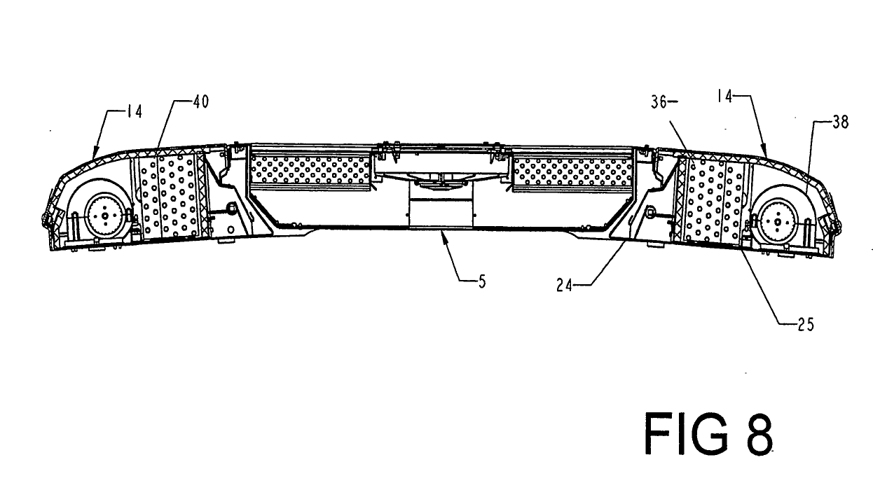

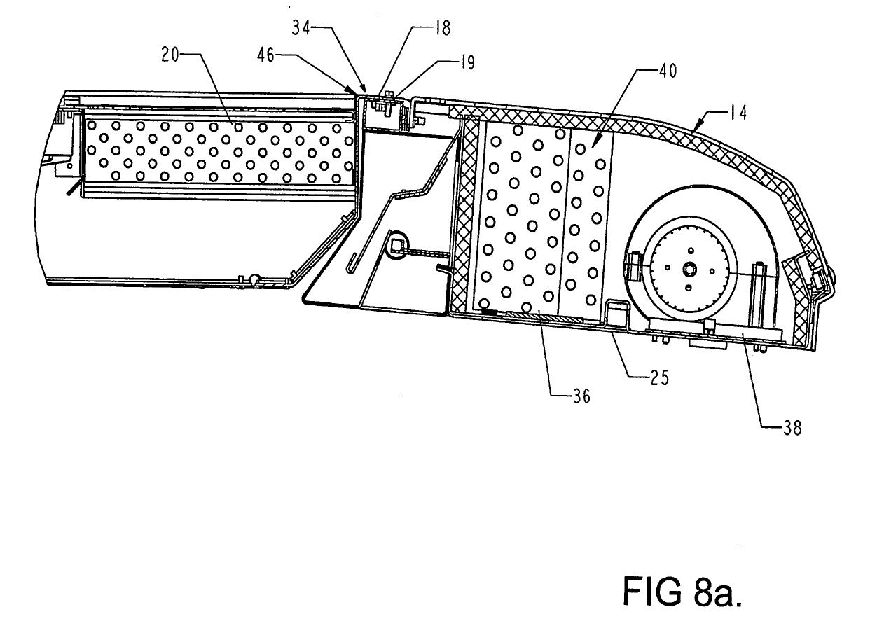

FIG. 8 A cross section through a rooftop air-conditioner according to the invention;

FIG. 8a An enlarged partial representation of FIG. 8;

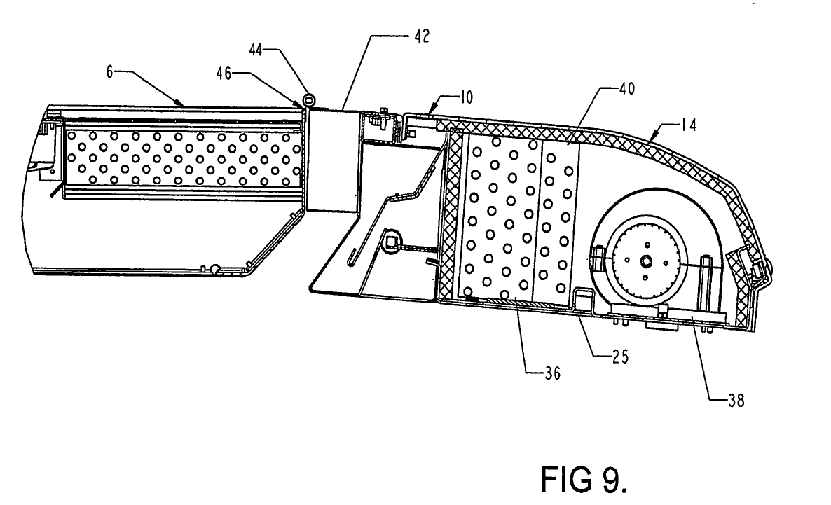

FIG. 9 A variation of FIG. 8a;

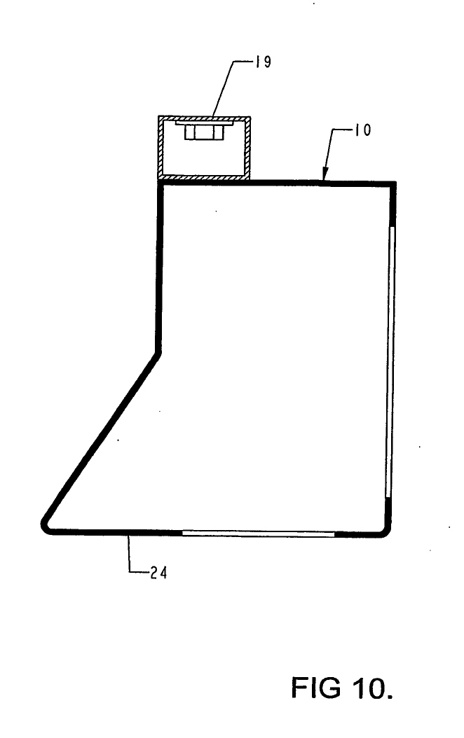

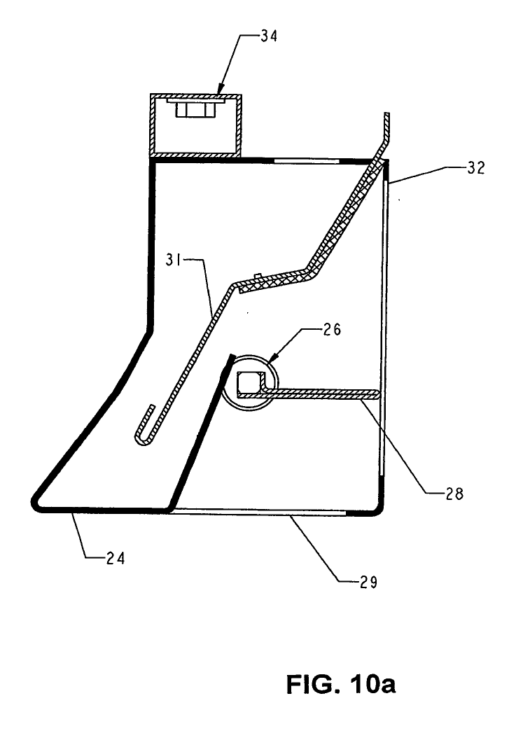

FIG. 10 An enlarged separate drawing of a section of the internal channel arrangement as a stand-alone module with housing;

FIG. 10a The same representation as FIG. 10 with the additional installation of an adjustable plate of a switching valve that can be adjusted between different operating modes of the air conditioning;

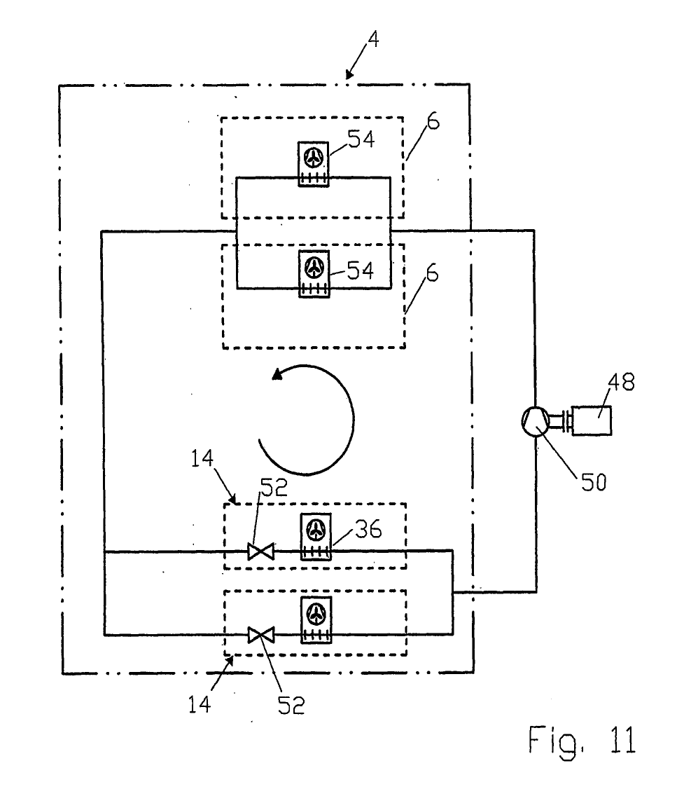

FIG. 11 A tube diagram of a rooftop air conditioner according to the invention;

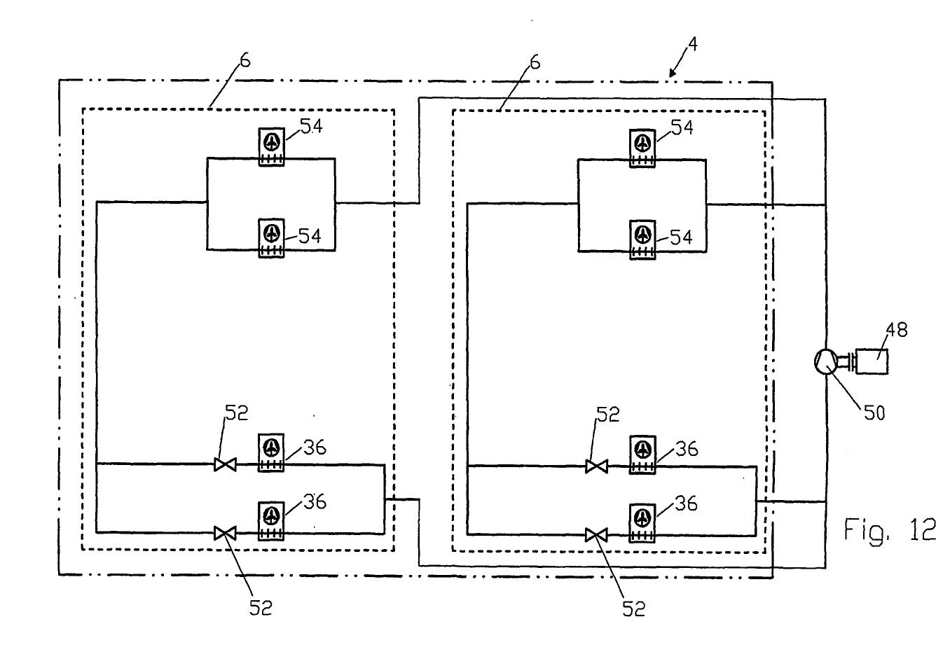

FIG. 12 An alternative to FIG. 11;

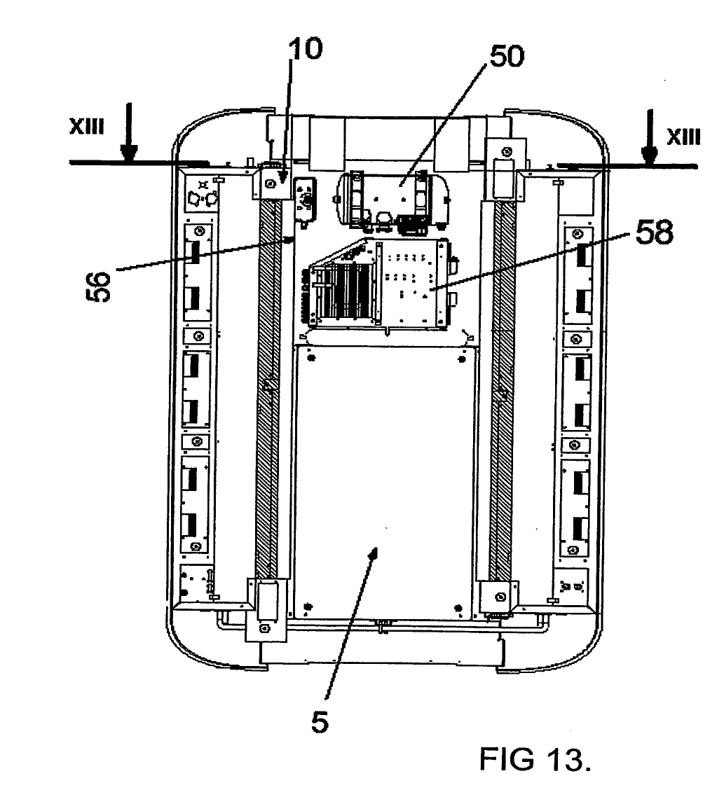

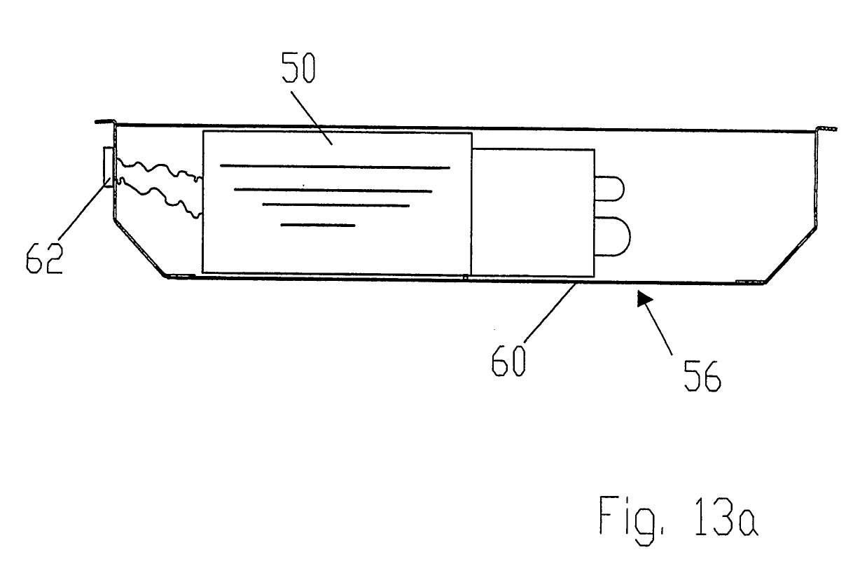

FIG. 13 A view of one possible embodiment of a rooftop air-conditioner according to the invention as seen from below;

FIG. 13a A sectional drawing along line XIII-XIII in FIG. 13;

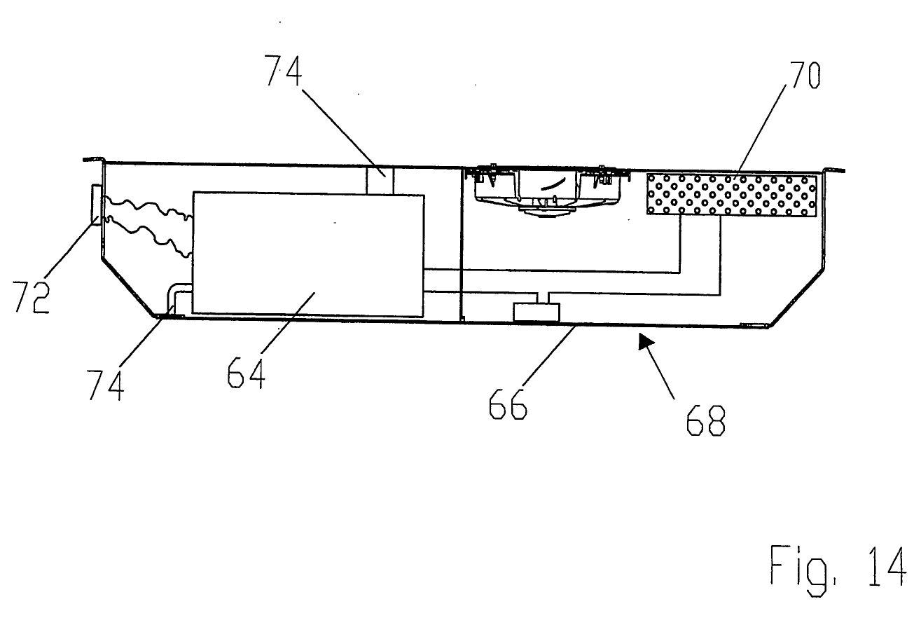

FIG. 14 A cross section through a stand-alone module of a fuel cell that is incorporated into the rooftop air-conditioner according to the invention;

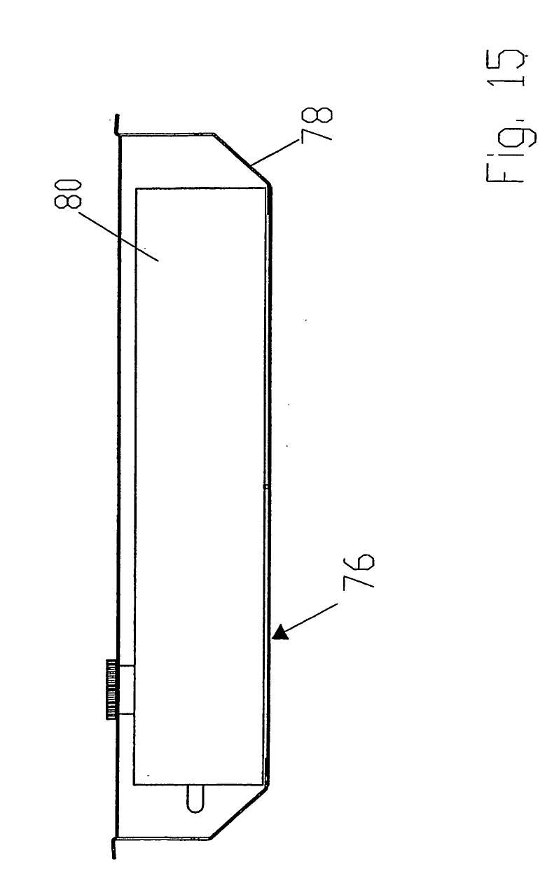

FIG. 15 A cross section through a stand-alone tank for fuel to a fuel cell of this type, wherein this tank is itself also configured as a stand-alone module with housing to be installed in the rooftop air-conditioner according to the invention; and

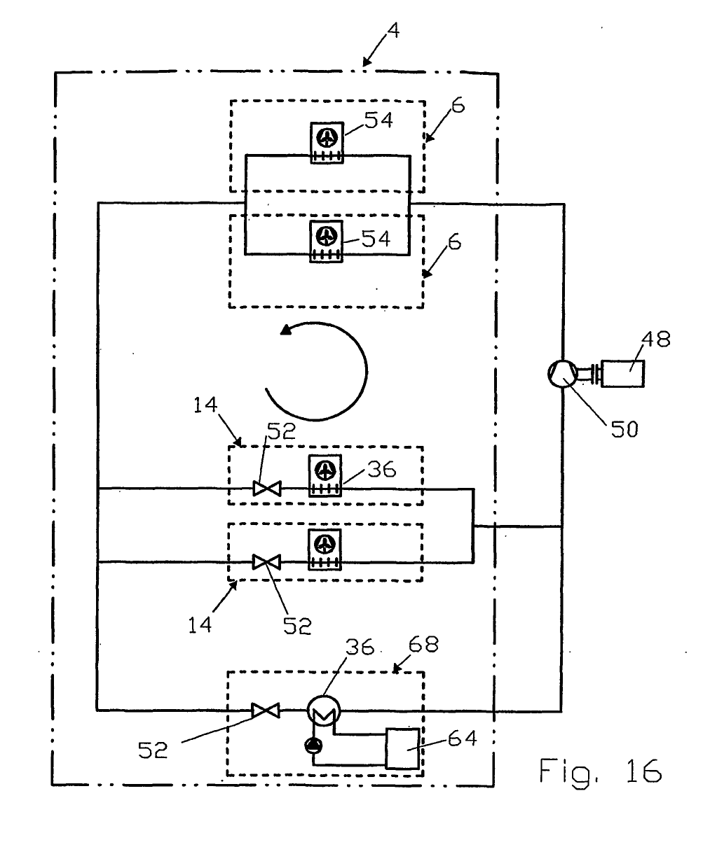

FIG. 16 An alternative to FIG. 11.

In FIG. 1, an installation surface 2 on the roof of a bus, which is not shown, is indicated by a dashed line; a first embodiment of a rooftop air-conditioner 4 is installed on this surface.

The rooftop air-conditioner is assembled here, as in most other embodiments, solely out of building block style modules that individually can have stepped nominal parameters. In each particular embodiment illustrated, all modules of a particular type have a prescribed exterior geometry independent of their nominal parameters, said geometry being determined by the particular module's housing.

The rooftop air-conditioner 4 according to FIG. 1 has various modules, each of which has an approximately rectangular base surface, which extends parallel to the longitudinal axis 3 of the installation surface 2. As seen in the width direction of the installation surface 2, a sequence of two high-pressure side heat exchanging device modules 6 is provided, said modules having different nominal outputs and being coupled together end to end with no lateral shift. The coupling means provided are overlapping wall projections 7 on the modules 6 that are fastened together with screws or rivets 8.

On both sides of the modules 6 and with essentially the same longitudinal length, modules 10 of an internal channel arrangement 12 to guide the air to be conditioned are arranged side by side. Along the outside of both, evaporation device modules 14 each extend in the same relationship.

The two modules 6 of the heat exchanging device differ from one another in FIG. 1 in nominal output in that in one module 6a, three fans 16 are installed whereas the other module 6b has only one installed fan 16 while maintaining the same longitudinal module length.

In FIG. 1, the fans are illustrated only through their cover gratings. In module 6b, there is an additional slot 17 that has no fan and no cover grating indicated; this can be equipped with a fan 16 together with cover grating if so chosen, as could a third slot 17 not shown, but is not so equipped. If the slot 17 is not filled, it must be closed off by means of a cover in a manner that is not shown.

Indicated between modules 6 and 10 are lateral connections 18, 19 of the same type as lateral connections 7, 8. Not shown, but similarly conceived are lateral connections between modules 10 and 14.

FIG. 2 varies the illustration in FIG. 1 only by equipping the slots 17 in module 6b, which is not occupied in FIG. 1, with another fan 16 with the cover grating shown.

When comparing FIGS. 1 and 2, it can be seen that a module 6 can be arbitrarily equipped with one fan 16 (FIG. 1), two fans 16 (FIG. 2) or three fans 16 (module 6a in FIGS. 1 and 2) while otherwise maintaining the same external geometry. In the process, three different nominal outputs can be produced in one module 6, respectively, while otherwise maintaining the same design of the module 6.

Also, both FIG. 1 and FIG. 2 indicate that the overall output of the high-pressure side heat exchanging device can be supplemented by combining two modules with different nominal outputs (nominal outputs one and three in FIG. 1 and two and three in FIG. 2).

In a manner not shown, other variations can be provided. In particular, possible variations include first of all back-to-back axial connection of more than two modules 6 and secondly the equipping of each module with more than three fans 16. For busses, it has been shown to be sufficient to use modules that have identical exterior geometries as in the exemplary embodiment but that vary in their nominal output between two, three and four fans.

The design of the modules can be seen in more detail in FIGS. 3 through 9.

In FIGS. 4 and 5, on one hand and 6 and 7 on the other, one can first see that the geometry of the tubes that convey the internal coolant can be arbitrary while otherwise maintaining identical external geometries and module sizes, in particular module heights. This is shown using round tubes 20 in FIGS. 3 through 5 and using flat tubes 21 in FIGS. 6 and 7, for example, wherein each of these tubes has an external fin 22. This fin 22 contacts the surrounding air, which cools the internal coolant in a conventional manner so as to dissipate the heat absorbed during the conditioning of the air in cooling mode.

The housing of the modules 6, or 6a and 6b, modules 10 and modules 14, in particular in FIG. 8 but in part also in the remaining figures, are identified by reference numbers 23, 24, and 25.

The housing 24 of the internal channel arrangement is drawn separately more clearly in FIGS. 10 and 10a.

In FIG. 10a, a switching valve 26 with an adjustable plate 28 is also shown inside the housing, said valve use to run the air to be conditioned that is passed through the internal channel arrangement 10 in a conventional manner in recycle mode, fresh air mode or mixed mode.

Designed into the housing 24 is an inlet opening 29 for the entering air to be conditioned coming from the interior of the vehicle, an inlet opening 30 for fresh air entering from outside that is passed through a baffle 31 to the switching valve 26, and an outlet opening 32 that directs the internal or external air to be conditioned to the evaporating device in module 14, depending on the mode of operation. Furthermore, FIG. 10 further illustrates the lateral connection 18, 19 in a manner that is described further below in detail with the aid of FIG. 8.

Module 10 can also be clearly identified in the center of the illustration in FIG. 8a.

Moreover, it is apparent that module 14 of the evaporation device contains the following other elements: first of all there is always an evaporation heat exchanger 36 that is in contact on the inside by the coolant and on the outside by the air to be conditioned that is passed through the internal channel arrangement. The evaporation heat exchanger 36 fits into the housing 25 with the same height thereas. The output can be varied by varying the number of blowers 38, only one of which is shown. For example, it is possible to use one to four blowers per module so that in fact twice the number of blowers and thus twice the evaporation output is produced when using a left and a right evaporation heat exchanger 36 due to the symmetrical arrangement on both sides of the modules 6. However, the number of blower 38 can also be increased or one can restrict oneself to the use of only one blower.

If the rooftop air-conditioner is used not only to cool the air to be conditioned, but also to alternatively heat it as well, a heating heat exchanger can be integrated into the evaporation device module 14 as well, said heat exchanger being heated with coolant from an internal combustion engine of the bus in the embodiment shown using round tubes and coming in contact as well on the outside by the air to be conditioned. The same applies naturally for the use of flat tubes. However, in a manner that is not shown, other heating elements can also be provided that are heated by means of electrical power instead.

In FIG. 8a, only round tubes are displayed, which could likewise be alternatively replaced by flat tubes.

In FIGS. 8a and 9 it can be see, for one thing, that each of the modules 6, 10 and 14 can be held apart laterally by means of a bridging device 42 to adjust to the width of the installation surface 2, said bridging device being slid in between module 6 and module 10. Another bridging device is not usually necessary, but could also be placed between modules 10 and 14 as necessary. One can see that the bridging device 42 is made up of a modular housing structure (shown only in FIG. 9).

Moreover, FIGS. 8a and 9 show that a relative bending of module 10 can be made with respect to module 6 to adjust to the surface curvature of the installation surface 2 in the width direction of the vehicle. In the process, FIG. 9 shows a hinged connection 44, whereas FIG. 8a indicates a soft bending connection 46.

The operating mode of the arrangements described thus far is illustrated below with the help of FIG. 11 ff. together with a few more logical supplementations.

From piping diagrams 11 and 12 for the internal coolant, the following internal coolant cycle can be seen as a possible operating mode: a compressing device or compressor 50 is mechanically driven by the engine 48 of the bus, said compressor raising the internal coolant from a state of low pressure to a state of higher pressure due to the effect of compression and conveying it to the heat exchanger tubing 20 and 21 of the heat exchanging device inside module 6, wherein heat is dissipated to the surrounding air at its external fins. The internal coolant is then conveyed in the compressor module 14 to an expansion device 52 where the internal coolant again transitions to a state of lower pressure and is conveyed to the compressing device 36 inside module 14 in this state. The expansion device 52 is mechanically connected to the compressing device 36. The internal coolant coming from the compressing device is again conveyed to the compressing device 50.

In the center of FIG. 11, the circulatory direction of the internal coolant is indicated symbolically with an arrow.

Whereas in the illustration according to FIG. 11 the evaporating device is located inside its own module 14, it can alternatively also be placed in module 6 of the high pressure-side heat exchanging device according to FIG. 12.

To simplify legibility, the high-pressure side heat exchanging device, which consists essentially of tubes 20 or 21 and its external fins 22, is indicated with the common reference 54.

In FIGS. 11 and 12, furthermore, the compressing device 50 is located outside the rooftop air-conditioner according to the invention near the engine of the vehicle. In FIG. 13, the preferred variation of the invention, the compressing device 50 is located in its own module 56 with its own housing and is fitted into a corresponding slot in the rooftop air-conditioner according to the invention. For better illustration, the lower cover plate of module 56 is taken away in FIG. 13. One can see that module 6 has a shorter longitudinal length than modules 10 and 14 and the compressing device 50 is fit into the space gained as a result. A conventional installation block for the electrical power supply and associated controls for the individual electrically driven components is displayed as well by reference 58.

In the sectional illustration according to FIG. 13a, the housing 60 of module 56 is seen schematically, both elements 50 and 58 as described being fit into it. Leading out of the housing 60 through an externally shown grommet is an electrical power line 62.

Similar to module 56, a fuel cell device 64 can be placed as an axial extension of module 6 or as an additional module of its own with its own housing 66, resulting in a separate module 68.

The required cooling cycle 70 of the fuel cell device, which is also contained in housing 66, is also indicated. Also, electrical connection lines 72 for the electrical energy produced in the fuel cell device as well as connections 74 and associated fuel cell device feed lines for incoming and outgoing fuel can be seen, which likewise pass through the housing 66.

FIG. 14 indicates an embodiment in which the fuel is fed to the module 68 from the outside and the consumed gas is discharged from it again.

In contrast, FIG. 15 again shows a stand-alone module 76 with its own housing 78 with a receiver tank 80 of fuel for the fuel cell device 64. This module 76 can be incorporated by itself or in combination with both modules 56 and 68, or only one of them, inside the rooftop air-conditioner 4, similar to the modules 56 and/or 68 described earlier. Here as well, individual openings to fill the tank as well as emptying lines to empty the fuel of the fuel cell device are additional logical concepts.

FIG. 16 shows an extension of FIG. 11 with a piping diagram in which the rooftop air-conditioner was supplemented by a module with a fuel cell device 68. Here, the internal coolant is provided to cool the fuel cell 64. The coolant, which is at a high pressure level, is throttled to a low pressure level by means of an expansion device 52 and conveyed to an evaporating device 36 to accomplish this. In the manner shown, the coolant in the cooling cycle 70 of the fuel cell is cooled (see claim 25). Alternatively, the cooling cycle can in turn be provided as an independent module that supplements the rooftop air-conditioner. Of course, alternatively or parallel with this, air cooled by internal coolant can be provided to cool the fuel cell.

1. A rooftop air-conditioner operating according to the cold vapor-compression principle using an internal coolant for a vehicle, in particular a bus, in which:
a sequence made up of a high-pressure side heat exchanging device with an associated fan devices, followed by an expansion device and an evaporation device that use the internal coolant;
an internal channel arrangement, relative to the rooftop air-conditioner, to convey air to be conditioned, which exchanges heat with the evaporation device;
and a modular construction of a high-pressure side heat exchanging device with associated fan device in its own housing
are provided;
characterized in that
connections for coupling of identical high-pressure heat exchanging device modules can be provided, prepared or designed; and
the modules are designed for grid-like coupling of modules of identical output and/or modules of stepped output.

2. A rooftop air-conditioner according to claim 1, characterized in that the coupling of the modules is done in the longitudinal direction of the vehicle.

3. A rooftop air-conditioner according to claim 1, characterized in that the high-pressure side heat exchanging device to convey the internal coolant contains round tubes.

4. A rooftop air-conditioner according to claim 1, characterized in that the high-pressure side heat exchanging device to convey the internal coolant contains flat tubes.

5. A rooftop air-conditioner according to claim 1, characterized in that the housing of the high-pressure side heat exchanging device is dimensioned such that either round tubes or flat tubes can be installed to convey the internal coolant.

6. A rooftop air-conditioner according to claim 1, provided with a heating device to heat the air to be conditioned.

7. A rooftop air-conditioner according to claim 6 characterized in that the heating device has at least one heating heat exchanger that is located inside the evaporation device with its exterior fins being aligned with the airway of the air to be conditioned and alongside the external fins of at least one evaporating heat exchanger.

8. A rooftop air-conditioner according to claim 1, characterized in that at least some, preferably all, modules in the grid are of the same longitudinal length.

9. A rooftop air-conditioner according to claim 1, characterized in that the module also contains an evaporating device and at least one section of an internal channel arrangement.

10. A rooftop air-conditioner according to claim 1, characterized in that the internal channel arrangement is provided separately from the module and is connected to it laterally.

11. A rooftop air-conditioner according to claim 1, characterized in that the evaporating device is arranged to the side of the internal channel arrangement.

12. A rooftop air-conditioner according to claim 1, characterized in that the evaporating device and/or the internal channel arrangement is itself designed modularly with its own housing.

13. A rooftop air-conditioner according to claim 1, characterized in that the air conditioner is subdivided in the transverse direction of the vehicle into sections and that the relative angular position between adjacent pairs of sections, is adjustable in the transverse direction of the vehicle.

14. A rooftop air-conditioner according to claim 13, characterized in that at least one pair of sections, is connected by means of a hinged and/or soft bending connection.

15. A rooftop air-conditioner according to claim 14, characterized by a bridging device slid in between the pairs of sections.

16. A rooftop air-conditioner according to claim 15, characterized in that different output levels of the module can be selected by using a different number of identical blower units that can be installed in the evaporating device and/or by a different number of identical fan units that can be installed in the high-pressure side heat exchanging device.

17. A rooftop air-conditioner according to claim 16, characterized in that the high-pressure side heat exchanging device, the evaporating device and the at least one section of inner channel arrangement each extends in the longitudinal direction of the vehicle.

18. A rooftop air-conditioner according to claim 17, characterized by a rooftop air-conditioner construction in the transverse direction with a central arrangement of high-pressure side heat exchanging device, inner channel arrangements on either side of said high-pressure side heat exchanging device, followed by evaporating devices on either side of said inner channel arrangements, said evaporating devices coupled to a respective expansion device.

19. A rooftop air-conditioner according to claim 18, characterized in that the inner channel arrangement of the rooftop air-conditioner has a space for installation of a switching valve to switch between conditioning the internal air in the vehicle, conditioning outside air fed to the vehicle, and/or a combination of the two.

20. A rooftop air-conditioner according to claim 19, characterized in that in at least one module, the high-pressure side heat exchanging device supplemented with a compression device addition to a fan devices.

21. A rooftop air-conditioner according to claim 20, characterized in that the supplemental compression device in turn is designed modularly with its own housing.

22. A rooftop air-conditioner according to claim 21, characterized in that in at least one module, the high-pressure side heat exchanging device is supplemented with a fuel cell device in addition to a fan device.

23. A rooftop air-conditioner according to claim 22, characterized in that the supplemental fuel cell device in turn is designed modularly with its own housing.

24. A rooftop air-conditioner according to claim 23, characterized in that the fuel cell device is provided with its own cooling device inside the rooftop air-conditioner or its own cooling module.

25. A rooftop air-conditioner according to claim 23, characterized in that the internal coolant is also provided as the coolant for the fuel cell device.

26. A rooftop air-conditioner according to claim 25, characterized in that a tank for the fuel of the fuel cell device is incorporated into the rooftop air-conditioner.

27. A rooftop air-conditioner according to claim 26, characterized in that the tank is designed as a module by itself.

28. A rooftop air-conditioner according to claim 26, characterized in that the tank is incorporated into the module of the fuel cell device.

29. A rooftop air-conditioner according to claim 28, having a supercritical operating mode and that the high-pressure heat exchanging device has a gas cooler for the internal coolant.
